(19) United States
(12) Patent Application Publication
(10) Pub. No.: US 2014/0185858 A1
(43) Pub. Date: Jul. 3, 2014

(54) LOUDSPEAKER

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventor: YAN-BANG CAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/949,244

(22) Filed: Jul. 24, 2013

(30) Foreign Application Priority Data
Dec. 28, 2012 (CN) 2012105785216

(51) Int. Cl. H04R 1/02

(52) U.S. Cl. CPC H04R 1/02
USPC 381/394

(57) ABSTRACT

A loudspeaker includes a shell, a circuit arranged within the shell, a negative pin electrically connected with the circuit, a positive pin electrically connected with the circuit, a flexible printed circuit board, and two spaced copper pads electrically attached on the flexible printed circuit board. Each of the negative and positive pins has a bent portion exposed outside the shell. The bent portions deformably abut against the copper pads respectively, thereby establishing an electrical connection between the circuit between the flexible printed circuit board.

### BACKGROUND

1. Technical Field

The disclosure relates to a loudspeaker and a loudspeaker having terminal pins with bent portions.

2. Description of Related Art

A loudspeaker is connected to a circuit board via two cables. In assembly, a user manually fuses the two cables to the circuit board via solders. However, it is very inconvenient to solder the cables to the circuit board.

Therefore, what is needed is a loudspeaker to overcome the described shortcoming.

### BRIEF DESCRIPTION OF THE DRAWINGS

FIG. 1 is a perspective view of an electronic device including two loudspeakers in accordance with an exemplary embodiment.

FIG. 2 is an exploded, perspective view of the electronic device of FIG. 1.

FIG. 3 is a perspective view of a loudspeaker of FIG. 2, but viewed from another angle.

FIG. 4 is a cross-sectional view of the electronic device of FIG. 1 taken along line IV-IV.

### DETAILED DESCRIPTION

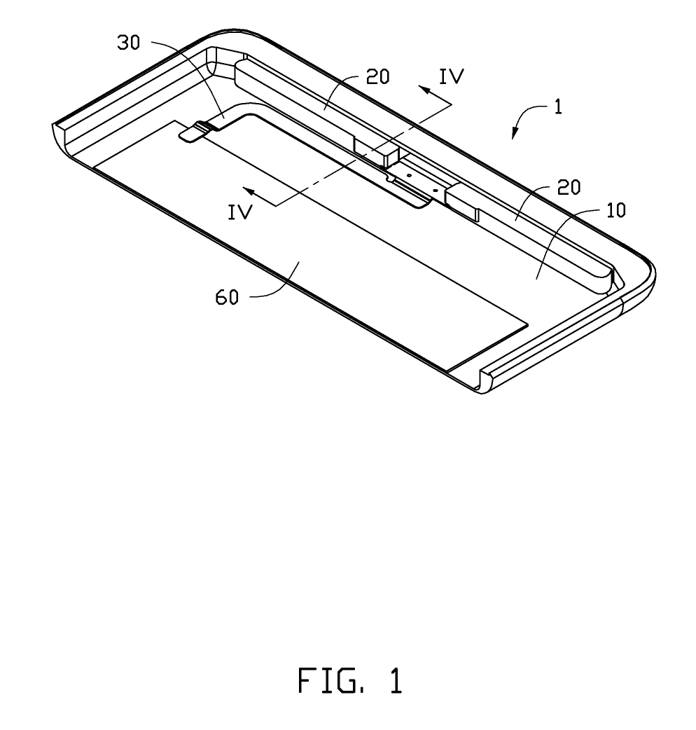

As shown in FIG. 1, an electronic device 1, such as a mobile phone or a tablet computer, includes at least one loudspeaker 20. In the embodiment, the electronic device 1 includes two loudspeakers 20. The two loudspeakers 20 have the same configuration. The electronic device 1 further includes a housing 10 and a circuit board 60. The circuit board 60 and the two loudspeakers 20 are received in the housing 10. The two loudspeakers 20 are connected to the circuit board 60 via a flexible printed circuit board 30.

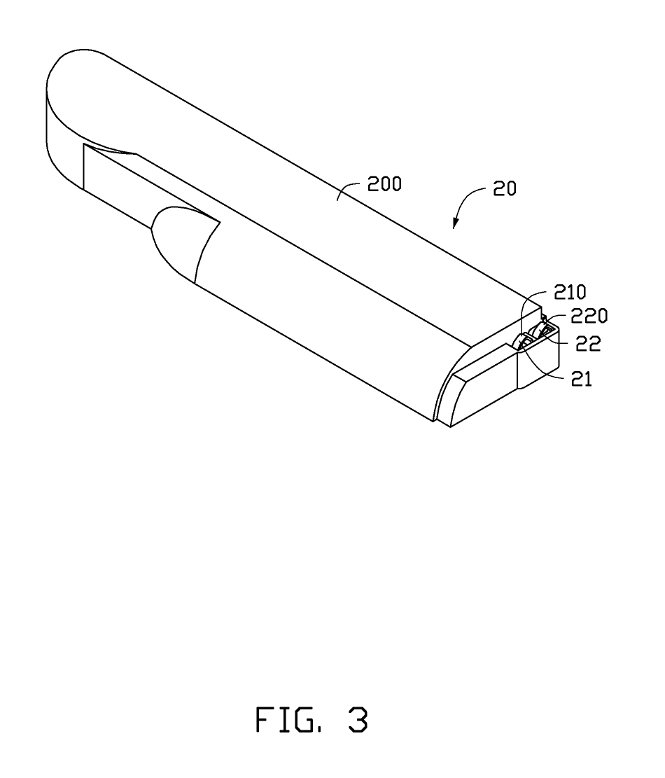

As shown in FIG. 3, each loudspeaker 20 includes a shell 200, a circuit (not shown), a negative pin 21, and a positive pin 22. The circuit is arranged within the shell 200. Both the negative and the positive pins 21, 22 are electrically connected with the circuit respectively. In the embodiment, both the negative and the positive pins 21, 22 are a pair of metal spring clips. The negative and the positive pins 21 and 22 have a bent shape. The negative pin 21 has a bent portion 210 exposed outside the shell 200. The positive pin 22 has a bent portion 220 exposed outside the shell 200. Both the bent portions 210, 220 are configured for electrical connection to the flexible printed circuit board 30.

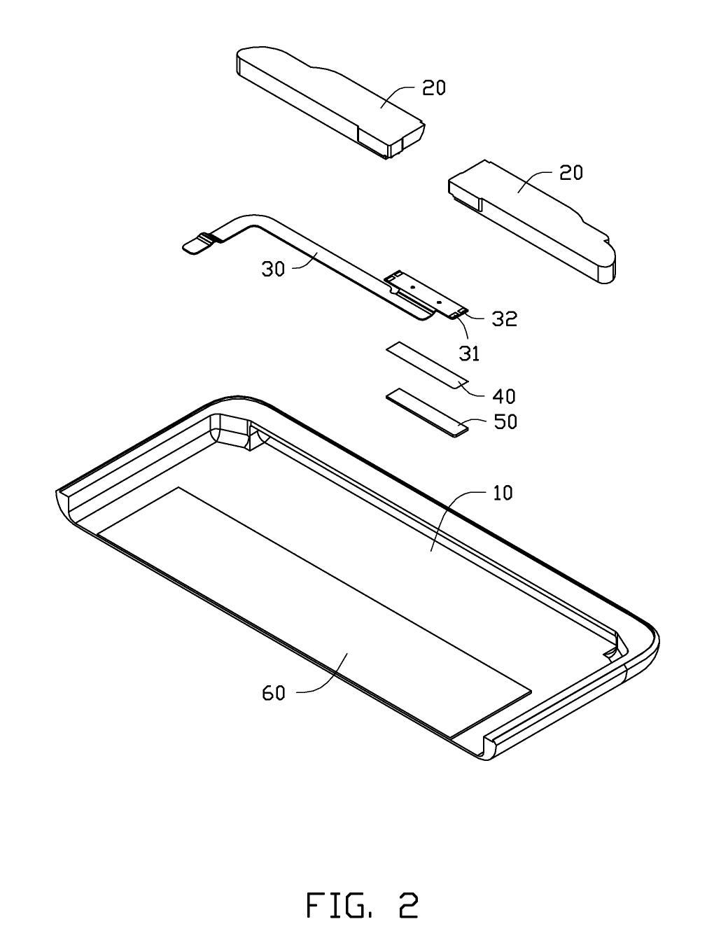

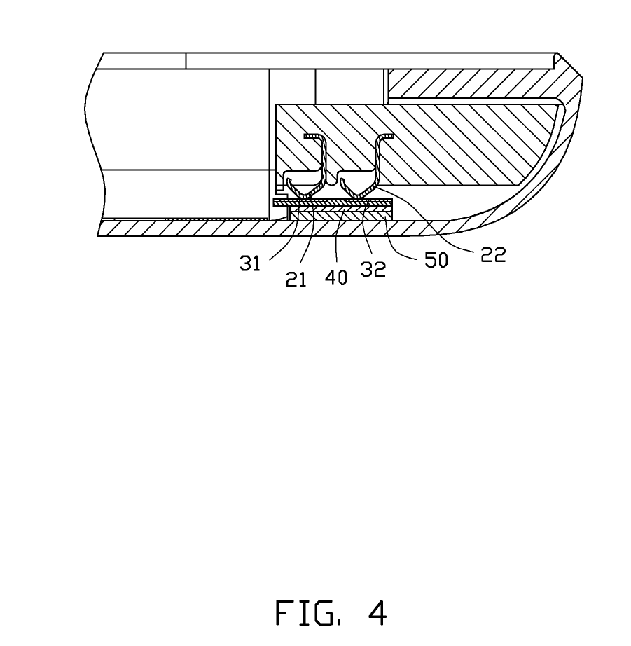

As shown in FIGS. 2 and 4, the flexible printed circuit board 30 is utilized to transmit signals between the loudspeakers 20 and the circuit board 60. The flexible printed circuit board 30 has a first end electrically connected to the circuit board 60 and an opposite second end. In the embodiment, the second end defines two sub-ends. Two spaced copper pads 31, 32 are electrically attached on a first side of each sub-end of the second end of the flexible printed circuit board 30. In another embodiment, the electronic device 1 includes a loudspeaker 20, and two spaced copper pads 31, 32 are electrically attached on a first side of the second end of the flexible printed circuit board 30.

The bent portion 210, 220 deformably abut against the two copper pads respectively, thereby establishing an electrical connection between the circuit between the flexible printed circuit board 30 and allowing signal transmission between the loudspeakers 20 and the circuit board 60.

Each loudspeaker 20 is fixed on the shell 10 via screws (not shown). A stiffener 40 is attached on an opposing second side of each sub-end of the second end of the flexible printed circuit board 30 for increasing a rigidity of the flexible printed circuit board 30. A foam block 50 is sandwiched between the stiffener 40 and a sidewall of the housing 10. The foam block 50 is under the stiffener 40. The foam block 50 supports the flexible printed circuit board 30 to prevent the flexible printed circuit board 30 from damaging the stiffener 40.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A loudspeaker comprising:
a shell;
a circuit arranged within the shell;
a negative pin electrically connected with the circuit; and
a positive pin electrically connected with the circuit;
wherein each of the negative and positive pins has a bent portion exposed outside the shell, the bent portions configured for electrical connection to an external circuit board.

2. A loudspeaker comprising:
a shell;
a circuit arranged within the shell;
a negative pin electrically connected with the circuit;
a positive pin electrically connected with the circuit;
a flexible printed circuit board; and
two spaced copper pads electrically attached on the flexible printed circuit board;
wherein each of the negative and positive pins has a bent portion exposed outside the shell, the bent portions deformably abut against the copper pads respectively, thereby establishing an electrical connection between the circuit between the flexible printed circuit board.

3. An electronic device comprising:
a housing;
a circuit board received in the housing;
a speaker received in the housing, comprising:
a shell;
a circuit arranged within the shell;
a negative pin electrically connected with the circuit;
a positive pin electrically connected with the circuit;
a flexible printed circuit board having a first end electrically coupled to the circuit board and an opposite second end;
two spaced copper pads electrically attached on a first side of the second end of the flexible printed circuit board; and
a stiffener attached on an opposing second side of the second end of the flexible printed circuit board;
wherein each of the negative and positive pins has a bent portion exposed outside the shell, the bent portions deformably abut against the copper pads respectively, thereby establishing an electrical connection between the circuit between the flexible printed circuit board.

4. The electronic device as recited in claim 3, wherein a foam block is sandwiched between the stiffener and a sidewall of the housing.
